(19) United States
(12) Patent Application Publication
(10) Pub. No.: US 2012/0068657 A1
(43) Pub. Date: Mar. 22, 2012

(54) ELECTRIC MACHINE SYSTEM INCLUDING AN ELECTRIC MACHINE HAVING SWITCHED STATOR WINDINGS

(75) Inventors: David A. Fulton, Anderson, IN (US); Rui Guan, Framingham, MA (US); Bradley D. Chamberlin, Pendleton, IN (US); Steven C. Burton, Anderson, IN (US)

(73) Assignee: REMY TECHNOLOGIES, L.L.C., Pendleton, IN (US)

(21) Appl. No.: 12/886,003

(22) Filed: Sep. 20, 2010

(51) Int. Cl. H02P 25/18

(52) U.S. Cl. 318/519

(57) ABSTRACT

An electric machine system includes an electric motor. The electric motor includes a stator having a plurality of windings that define a number of phases. A plurality of switch members are operatively coupled to the plurality of windings. The plurality of switch members are no more than one less than three times the number of phases. A controller is operatively coupled to the plurality of switch members. The controller selectively changes a state of the plurality of switch members to establish one of a first electrical connection configuration of the plurality of windings and a second electrical connection configuration of the plurality of windings.

### BACKGROUND OF THE INVENTION

Exemplary embodiments pertain to the art of electric machines and, more particularly, to an electric machine having switched stator windings.

A wide array of devices are now relying on electric machines for power. Electric powered transportation and hybrid electric machines are currently becoming more common as viable alternatives to fossil fuel powered vehicles. As electric powered vehicles grow in popularity, there is a need to enhance electric motor output efficiency.

Currently, electric motor output falls into a defined efficiency range. Greater efficiency is achieved when the electric motor is operating near base speed. Operating outside the base speed is less than optimal. That is, under various operating conditions, output torque from the electric motor may be outside a desired operating envelope. One area of current exploration to improve electric motor performance is inverter technology. Adjustable speed motor control inverters are currently used to power traction motors employed in certain electric and hybrid electric vehicles. Improvements in motor control inverter technology is one path toward enhanced operational efficiency of electric motors.

### BRIEF DESCRIPTION OF THE INVENTION

Disclosed is an electric machine system including an electric motor. The electric motor includes a stator having a plurality of windings that define a number of phases. A plurality of switch members are operatively coupled to the plurality of windings. The plurality of switch members are no more than one less than three times the number of phases. A controller is operatively coupled to the plurality of switch members. The controller selectively changes a state of the plurality of switch members to establish one of a first electrical connection configuration of the plurality of windings and a second electrical connection configuration of the plurality of windings.

Also disclosed is a method of operating an electric machine. The method includes selectively connecting a plurality of stator windings of the electric machine in one of a first electrical connection configuration and a second electrical connection configuration. The plurality of stator windings define a number of phases. The method also includes passing an electrical current through the plurality of stator windings, sensing an operational parameter of the electric machine, and selectively engaging a plurality of switch members to switch the plurality of stator windings to the other of the first electrical connection configuration and the second electrical connection configuration when the operational parameter is a predetermined value. The plurality of switch members are no more than one less than three times the number of phases.

### BRIEF DESCRIPTION OF THE DRAWINGS

The following descriptions should not be considered limiting in any way. With reference to the accompanying drawings, like elements are numbered alike:

FIG. 1 depicts an electric machine system including an electric machine having switched stator windings in accordance with an exemplary embodiment; and

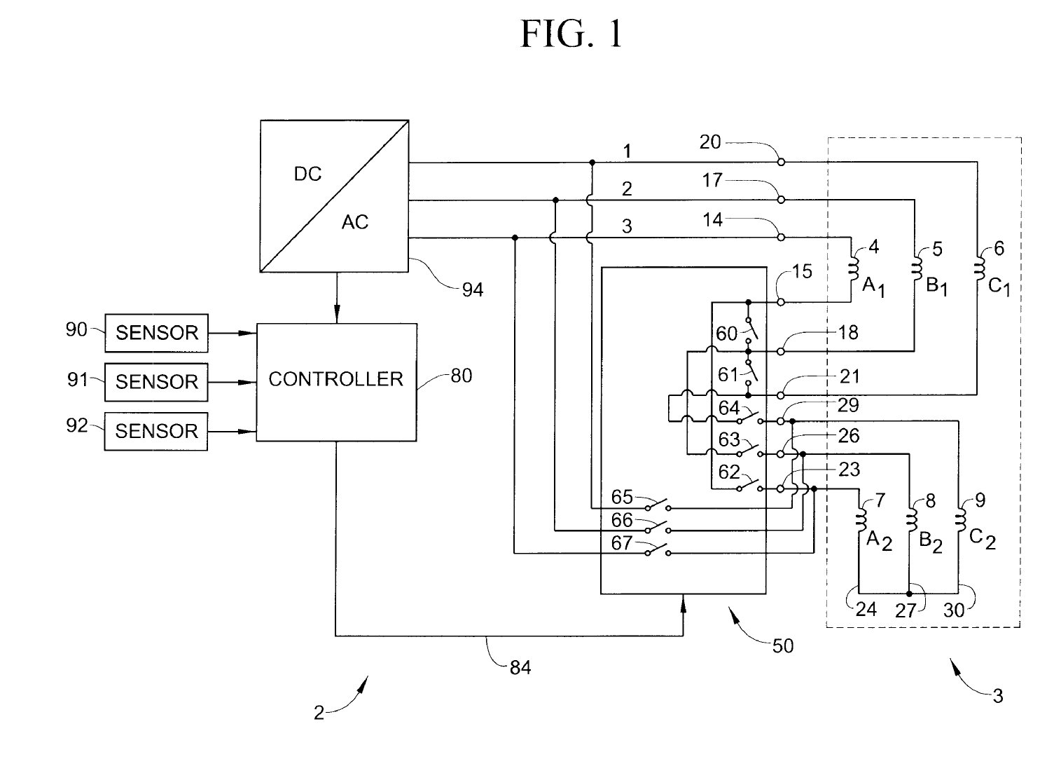

FIG. 2 depicts a graph illustrating an operational range for a series configuration of the switched stator windings and a parallel configured for the switched stator windings of the electric machine of FIG. 1.

### DETAILED DESCRIPTION OF THE INVENTION

A detailed description of one or more embodiments of the disclosed apparatus and method are presented herein by way of exemplification and not limitation with reference to the Figures.

An electric machine system in accordance with an exemplary embodiment is indicated generally at 2. Electric machine system 2 includes an electric machine, shown in the form of an electric motor 3, having a plurality of stator windings 4-9 that define a number of phases A, B, C. Stator windings 4-9 are arranged in pairs with phase A including windings 4 and 7, phase B including windings 5 and 8 and phase C including windings 6 and 9. In the exemplary embodiment shown, winding 4 includes a first end 14 that extends to a second end 15. Similarly, winding 5 includes a first end 17 and a second end 18; winding 6 includes a first end 20 and a second end 21; winding 7 includes a first end 23 and a second end 24; winding 8 includes a first end 26 and a second end 27; and winding 9 includes a first end 29 and a second end 30.

Electric machine system 2 includes a switch housing 50 that, in accordance with the exemplary embodiment shown, is provided at electric motor 3. Switch housing 50 includes a plurality of switch members 60-67 operatively connected to windings 4-9. As shown, switch member 60 couples second end 15 of winding 4 with second end 18 of winding 5. Switch member 61 couples second end 18 of winding 5 with second end 21 of winding 6; switch member 62 couples second end 21 of winding 6 with first end 29 of winding 9; switch member 63 couples second end 18 of winding 5 with first end 26 of winding 8; and switch member 64 couples second end 15 of winding 4 with first end 23 of winding 7. Finally, switch members 65-67 connect line voltage to first ends 29, 26, and 23 of windings 9, 8, and 7 respectively.

In accordance with the exemplary embodiment, the number of switches operatively connected to the plurality of stator windings is established by the equation 2(m)−1 where (m) is the number of phases. More specifically, the number of switch members is no more than one less than twice the number of phases. In the present case, the number of switch members 4-9 is no more than eight. In accordance with one aspect of the exemplary embodiment, switch members 60-67 take the form of insulated-gate bipolar transistors (IGBTs). However, it should be understood that a wide array of various switching components can be employed such as metal-oxide semiconductor field effect transistors (MOSFETS).

In further accordance with the exemplary embodiment, electric machine system 2 includes a controller 80 operatively connected to switch members 60-67 through a signal line 84. In accordance with one aspect of the exemplary embodiment, controller 80 takes the form of a microcontroller (combination of microprocessor and modules for input/output signals) or a digital signal processor (DSP). As will be discussed more fully below, controller 80 selectively sends signals to switch housing 50 to change a state of select ones of switch members 60-67. By change state, it should be understood to mean that controller 80 signals switch members 60-67 to open and/or close. Controller 80 is also operatively connected to a plurality of sensors 90, 91, and 92 and an inverter 94 that provides power to electric motor 3. In accordance with one aspect of the exemplary embodiment, sensors 90-92 detect a speed of the output shaft (not shown), output shaft torque, and current draw of electric motor 3 respectively. Of course it should be understood that controller 80 could also include sensors that detect various other parameters, either singly or in combination, of electric motor 3.

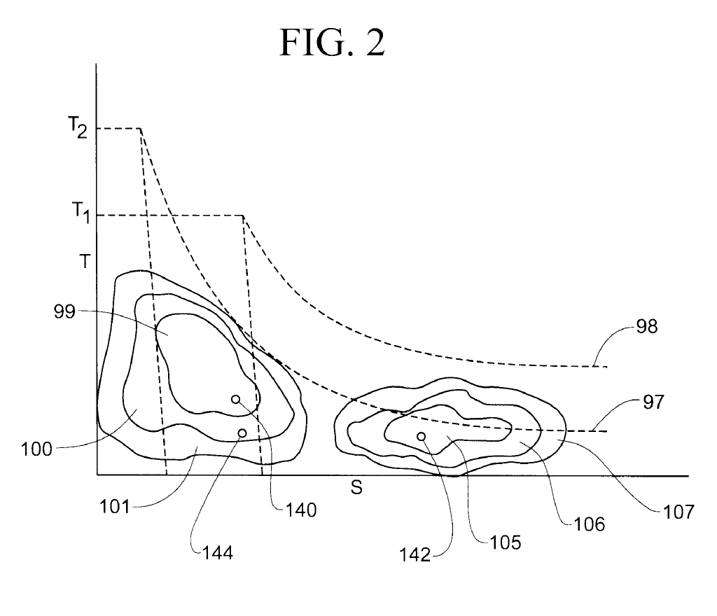

In accordance with an exemplary embodiment, stator windings 4-9 are selectively connected in one of a first electrical connection configuration and a second electrical connection configuration. In accordance with one aspect of the exemplary embodiment, the first electrical connection configuration is a series connection and the second electrical connection configuration is a parallel connection. The particular electrical connection configuration employed depends upon operating conditions for electric motor 3. In a series configuration, switch members 60 and 61 are open, switch members 62-64 are closed and switch members 65-67 are open. In a parallel configuration, switch members 60 and 61 are closed, switch member 62-64 are open, and switch members 65-67 are closed. When in a series configuration, electric motor 3 has a first operational curve such as shown at 97 in FIG. 2. First operational curve 97 includes a first corner point T₁. When in a parallel configuration, electric motor 3 has a second operational curve 98. Second operational curve 98 has a second corner point T₂. In the exemplary embodiment shown, first operational curve 97 includes a plurality of desired efficiency ranges 99-101. Efficiency range 99 represents about a 95% efficiency, efficiency range 100 represents about a 90% efficiency, and efficiency range 101 represents about an 85% efficiency. Similarly, second operational curve 98 includes a plurality of efficiency ranges 105-107. Efficiency range 105 represents about a 95% efficiency, efficiency range 106 represents about a 90% efficiency and efficiency range 106 represents about an 85% efficiency. Of course, it should be understood that in addition to series and parallel connections, stator windings 4-9 may be selectively connected in a wide variety of electrical connection configurations including wye connections, delta connections and/or combinations thereof. As will be discussed more fully below, controller 80 switches corner points, e.g., between series and parallel configuration to maintain operation of electric motor 3 in the highest desired efficiency range. For example, when electric motor 3 is at operation point such as shown at 140, efficiency is higher when windings 4-9 are arranged in a series configuration. When electric motor 3 is at an operation point such as shown at 142, efficiency is higher when windings 4-9 are in a parallel configuration; and when electric motor 3 is operating at a point such as shown at 144, efficiency is higher when windings 4-9 are in the series configuration.

In accordance with an exemplary embodiment, controller 80 endeavors to ensure that electric motor 3 is operating in the desired operating range for a particular configuration. For example, if electric motor 3 is connected in a series configuration, and operating outside desired operating range 99, controller 80 determines whether switching to a parallel configuration is appropriate. More specifically, controller 80 utilizes input from one or more of sensors 90-92 to determine speed and/or torque of the output shaft and/or current drawn by electric motor 3. Controller 80 then determines, utilizing for example a look up table, whether switching to a parallel configuration will result in electric motor 3 operating within operational range 100. If switching is appropriate, a signal is passed through signal line 84 to selectively open and close appropriate ones of switch members 60-67 to establish the desired configuration. During switching, power may be temporarily interrupted to electric motor 3 to ensure a “soft” change over. By soft change over, it should be understood that controller 80 endeavors to ensure that the transition between series and parallel configurations is smooth, e.g. without noticeable hesitation and the like. In addition, controller 80 employs a hysteresis to prevent repeated switches if electric motor 3 is operating on the cusp of one or the other desired operational range 99, 100.

At this point it should be understood that the exemplary embodiments provide a system for selectively switching an electric motor between series and parallel configuration to proactively ensure operations within a desired operational envelope to minimize energy consumption and extend operational life of batteries and the like. In addition, the exemplary embodiment employs a minimal number of switches to reduce cost and complexity of operation. The exemplary embodiments lead to the use of fewer switches, e.g., 3m−1 switches for an “m” phase electric machine, resulting in a lower cost and complexity, a smaller circuit footprint, and fewer failure points. The exemplary embodiments also reduce the overall number of required terminations and power cables and are adaptable to machines having any number of phases.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine system comprising:
an electric motor including a stator having a plurality of windings that define a number of phases;
a plurality of switch members operatively coupled to the plurality of windings, the plurality of switch members being no more than one less than three times the number of phases; and
a controller operatively coupled to the plurality of switch members, the controller selectively changing a state of the plurality of switch members to establish one of a first electrical connection configuration of the plurality of windings and a second electrical connection configuration of the plurality of windings.

2. The electric machine system of claim 1, wherein the first electrical connection configuration is a series connection of the plurality of windings and the second electrical connection configuration is a parallel connection of the plurality of windings.

3. The electric machine system according to claim 1, wherein the plurality of switch members comprise insulated-gate bipolar transistors (IGBTs).

4. The electric machine system according to claim 1, wherein the plurality of switch member comprise metal-oxide semiconductor field effect transistors (MOSFETS).

5. The electric machine system according to claim 1, wherein the plurality of windings define three phases.

6. The electric machine system according to claim 5, wherein the plurality of switch members comprise no more than eight switch members.

7. The electric machine system according to claim 1, further comprising: an inverter member operatively connected to the plurality of windings of the electric motor.

8. The electric machine system according to claim 7, wherein the plurality of switch members are arranged at the electric motor.

9. The electric machine system according to claim 7, further comprising: a plurality of cables connecting the inverter member and select ones of the plurality of switch members, the plurality of cables including a number of cables that is the same as the number of phases.

10. The electric machine system according to claim 7, wherein the controller is mounted at the inverter.

11. The electric machine system according to claim 10, further comprising: a signal line extending between the inverter and the plurality of switch members, the signal line passing a switch signal to select ones of the plurality of switch members.

12. The electric machine system according to claim 1, further comprising: a sensor electrically connected to the controller, the controller selectively changing the state of the plurality of switch members based on an operational parameter sensed by the sensor.

13. The electric machine system according to claim 12, wherein the sensor is one of a speed sensor, a torque sensor, and a current sensor.

14. A method of operating an electric machine, the method comprising:
selectively connecting a plurality of stator windings of the electric machine in one of a first electrical connection configuration and a second connection electrical configuration, the plurality of stator windings defining a number of phases;
passing an electrical current through the plurality of stator windings;
sensing an operational parameter of the electric machine; and
selectively engaging a plurality of switch members to switch the plurality of stator windings to the other of the first electrical connection configuration and the second connection electrical configuration when the operational parameter is a predetermined value, the plurality of switch members being no more than one less than three times the number of phases.

15. The method of claim 14, wherein sensing an operational parameter of the electric machine includes detecting one of a torque value and a speed value of an output shaft of the electric machine.

16. The method of claim 14, wherein sensing an operational parameter of the electric machine includes detecting an electrical current passing through the electric machine.

17. The method of claim 14, wherein selectively connecting the plurality of stator windings of the electric machine in one of the first electrical connection configuration and the second electrical connection configuration comprises selectively connecting the plurality of stator windings in one of a series connection and a parallel connection.
